(19) United States
(12) Patent Application Publication
(10) Pub. No.: US 2009/0299835 A1
(43) Pub. Date: Dec. 3, 2009

(54) Method of Soliciting, Testing and Selecting Ads to improve the Effectiveness of an Advertising Campaign

(76) Inventors: David Greenbaum, Aventura, FL (US); Rob Lenderman, Miami, FL (US)

Correspondence Address: WHITE-WELKER & WELKER, LLC, P.O. BOX 199, CLEAR SPRING, MD, 21722-0199, US

(21) Appl. No.: 12/131,509

(22) Filed: Jun. 2, 2008

(51) Int. Cl. G06Q 30/00

(52) U.S. Cl. 705/14.2

(57) ABSTRACT

Method for advertisers to improve ad metrics through performance based prize Competitions. A business method that enables advertisers to host prize competitions that attract and motivate ad-writers to create better ads, resulting in higher click-through-rates (CTR). Advertisers challenge writers to beat the performance of their existing ads by offering cash prizes tied to the annual CPC savings their ads generate. The method automatically advertises competitions, queues submitted ads, A/B tests them, selects the ad with the highest CTR, oversees payouts (if any), and restarts the competition with the next submission. The present invention builds a base of professional writers who specialize in multiple categories of businesses. These writers are motivated by the cash prizes but also by improving their skills over multiple challenges.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to online advertising. More specifically, the present invention relates to a method for online advertisers to improve the effectiveness of their online advertisements using competitions with performance based incentives.

### BACKGROUND OF THE INVENTION

The present invention enables advertisers to host prize competitions that attract and motivate top ad-writers to create better ads, resulting in higher click-through-rates (CTR). The present invention addresses a large and growing market—the tens of thousands of online advertising accounts that employ text ads on search engine result pages. With the present invention, advertisers challenge writers to beat the performance of their existing ads by offering cash prizes tied to the annual CPC savings their ads generate.

Writing online ads is challenging; a high level of skill required to convey an advertising message using a fixed number of characters. For this reason, expert marketers can often achieve substantial CTR improvements over ads produced by non-experts. The present invention will generate tremendous value for advertisers by connecting them with a multitude of ad-writing experts.

Unlike typical search engine marketing agencies, the present invention is risk-free to advertisers; they pay nothing to establish Competitions; instead, writers are paid a prize (calculated as a percentage of annual savings) whenever their ad improves upon the CTR of a challenged ad. Advertisers are happy to pay this prize because a higher CTR drives cost-per-click (CPC) lower (holding all other variables the same). The present invention receives a commission from the advertiser on top of the prize for its efforts.

Having an automated system for generating and testing ads allows advertisers to maintain a leaner, more analytics-focused marketing team. The present invention automatically advertises competitions, queues submitted ads, A/B tests them, selects the ad with the highest CTR, oversees payouts, if any, and restarts the process with the next submission. This enables marketing staff to focus on the “hard” skills of managing PPC bids, budgets, and terms, rather than the “soft” skills of writing compelling ads. In this manner, the present invention fills a void in the online marketing landscape—small businesses do not have the resources to hire professional ad writers, and large businesses have neither the time nor the resources to manage an optimal number of ad groups.

The present invention will build a base of professional writers who specialize in multiple categories of businesses. These writers are motivated by the cash prizes, but also by improving their skills over multiple challenges. Professional writers can generate many ads per day, earning substantial income. Moreover, a writer's ranking/score provides a verifiable means for claiming expertise to all clients.

Other prior art systems have been proposed, but have all failed from one or more of the shortcomings previously discussed. For example, US Patent Application publication 20070250378 discloses methods and a system for compensating contestants for participating in development competitions. In one embodiment, a method for compensating contestants for participating in development competitions includes conducting development competitions in which contestants each submit a development, and for each competition evaluating contestants' submissions; based on the evaluation, assigning a score to contestants' submissions, identifying a number of submissions having a score above a threshold value, designating the contestant who submitted a submission having a score above the threshold value that is the highest score to be the winner of that competition, and awarding performance points to contestants who submitted the identified submissions. The method further includes periodically awarding prizes to the contestants who receive the greatest number of performance points during the period.

US Patent Application publication 20070288107 discloses a system and method for screening submissions in a production contest system. In one embodiment, the method includes receiving a production competition submission from a contestant, automatically screening the submission with a screening system to verify that the submission meets predetermined requirements, and providing feedback to the contestant and a contest administrator regarding the results of whether the submission meets the predetermined requirements.

U.S. Pat. No. 7,162,417 teaches a system and method that provides content review, distribution, ranking and access and automate creation and performance of contests among sets of content-based contestants. The system and method provide customizable interactive, ongoing, multi-level, multi-round contests with expert review of and filtered submission of content-based contestants. Among other advantages, providers may use the system and method to obtain expert and consumer review and ranking of their content.

U.S. Pat. No. 7,162,417 teaches a system and method that provides content review, distribution, ranking and access and automate creation and performance of contests among sets of content-based contestants. The system and method provide customizable interactive, ongoing, multi-level, multi-round contests with expert review of and filtered submission of content-based contestants. Among other advantages, providers may use the system and method to obtain expert and consumer review and ranking of their content.

US Patent Application publication 20040148222 discloses a method and a system for online advertising in an advertisement auction environment. A current cost per click (CPC) for the advertisement is calculated. A click through rate (CTR) for the advertisement is calculated. An effective cost for the advertisement is calculated. Also, effective costs of a set of advertisements are calculated. The effective cost of the advertisement is compared with the effective costs of the set of advertisements to determine rankings of the advertisement and the set of advertisements. Priority statuses of the advertisement and of the set of advertisements are determined. A first set of data is transmitted to an advertiser that includes the effective cost for the advertisement, the effective costs of the set of advertisements, the rankings of the advertisement and the set of advertisements, the maximum price to the first priority status, the click through rate of the advertisement, the first rank status click through rate (the CTR for the best performing advertisement), a maximum price for a collection of advertisements that the advertisement is associated with, the priority statuses of the advertisements, and other data. A second set of data is received from the advertiser that includes changes to the advertisement and to the current CPC of the advertisement.

What is needed is an automated system for generating and testing ads that allows advertisers to maintain a leaner, more analytics-focused marketing team.

Finally, what is also needed is a means for automatically advertising Competitions, queuing submitted ads, manually accepting them, A/B testing them, selecting the ad with the highest CTR, overseeing payouts (if any), and moving on to the next challenge ad.

### SUMMARY OF THE INVENTION

The present invention is business method that enables advertisers to host prize competitions that attract and motivate ad-writers to create better ads, resulting in higher click-through-rates (CTR). With The present invention, advertisers challenge writers to beat the performance of their existing ads by offering cash prizes tied to the annual CPC savings their ads generate.

Having an automated system for generating and testing ads allows advertisers to maintain a leaner, more analytics-focused marketing team. The present invention automatically advertises competitions, queues submitted ads, A/B tests them, selects the ad with the highest CTR, oversees payouts, if any, and restarts the competition with the next submission. This enables marketing staff to focus on the “hard” skills of managing PPC bids, budgets, and terms, rather than the “soft” skills of writing compelling ads. In this manner, the present invention fills a void in the online marketing landscape—small businesses do not have the resources to hire professional ad writers, and large businesses have neither the time nor the resources to manage an optimal number of ad groups.

The present invention will build a base of professional writers who specialize in multiple categories of businesses. These writers are not only motivated by the cash prizes, but also by improving their skills over multiple challenges. Professional writers can generate many ads per day, earning substantial income. Moreover, a writer's present invention ranking/score provides a verifiable means for claiming expertise to all clients.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the relationship of events in the present invention;

FIG. 2 is a flow chart illustrating the process for the creation of a Champion Ad;

FIG. 3 is flow chart illustrating the process for an Advertiser to practice the present invention is shown;

FIG. 4 is a flow chart illustrating the process for a Challenger to use the practice the present invention; and

FIG. 5 is a flow chart illustrating the system structure for a Competition as taught by the process and method of the present invention.

### DEFINITIONS OF IMPORTANT TERMS AND ACRONYMS

### Entities

Advertiser is defined as someone that creates a Competition to improve the performance of his advertisement.

A Challenger is defined as one who generates a Challenger Ad to compete against the existing Champion Ad to become the new Champion Ad.

OAA is defined as “Online Advertising Account”, whereby one example of an OOA would be Google's AdWords.

### Competition Terms

A Challenge is defined as the testing of a Challenger Ad against a Champion Ad in a Competition to determine the one with the best success metric.

A Competition is defined as a series of Challenges for a particular Ad Group.

A Champion Ad or Champion is defined as a current advertisement with the best performance or the Advertiser's advertisement at the initiation of a Challenge.

The Challenger Ad or Challenger is defined as the advertisement generated by the Challenger to compete against the Champion Ad.

A Success metric is defined as an Objective or Subjective metric.

An Ad Group is defined as a collection of one or more ads competing against a Champion Ad.

A Competition Queue is defined as a series of Challenger Ads waiting to run next in a Competition.

### DETAILED DESCRIPTION OF THE INVENTION

In the following are detailed descriptions of the invention of exemplary embodiments. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

The present invention enables Advertisers to host Competitions that attract and motivate Challengers to create better ads, resulting in better performance as measured by a Success Metric (e.g. improved click-through-rate). With this invention, Advertisers challenge writers to beat the performance of their existing ads by offering incentives tied to the improvement in the ad's Success Metric.

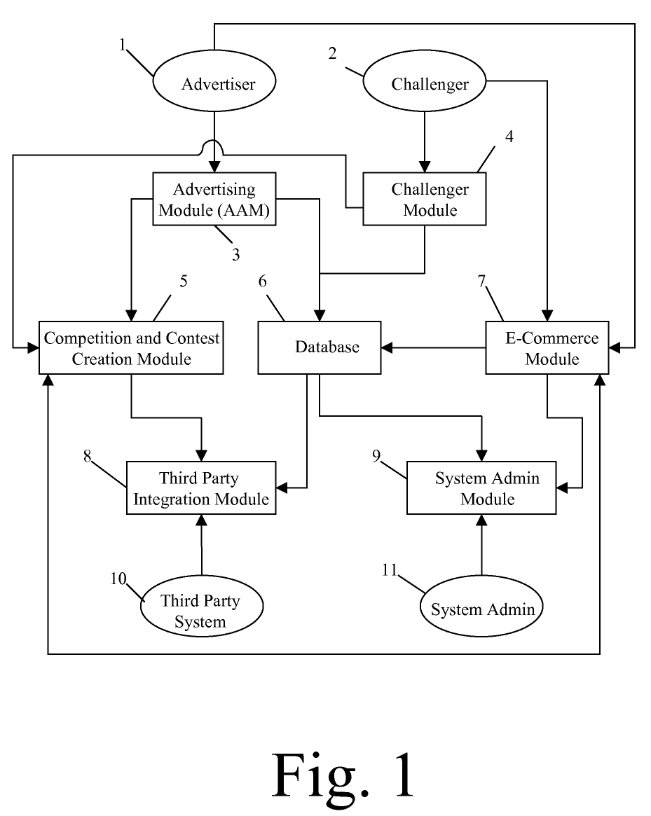

Now referring to FIG. 1, Advertisers 1 provide access to their existing online advertising accounts (OAA) hosted with third party partners 10 such as Google, Yahoo, MSN and others via the Third Party Integration Module 8. The present invention accesses the account using an account access advertising module (AAM) 3. The AAM 3 identifies all Ad Group and ads within the Ad Groups in the OAA and stores them in the database 6. The Advertiser 1 is given the choice of launching Competitions from the Competition Contest Module 5 to improve any ad groupings and ads they want to improve. Next, the AAM 3 uses all of the ads found in the previous step to find the highest Success Metric in each ad grouping (also referred to as Ad Groups). The ad with the highest Success Metric is identified as the Champion Ad to be improved on. Thus, this Success Metric establishes the threshold for winning future Challenges until a new Success Metric is established by the next Champion. In an alternative embodiments, the present invention can create new Ad Groups and either automatically or manually create a Champion Ad.

The Competition and Contest Creation Module (CCCM) 5 creates Competitions and Contests for each of the selected Champion Ads by Challengers 2. A Competition consists of: An Ad Group, a Champion Ad, a Success Metric (typically click through rate), and a set of rules governing the Competition.

The Advertiser 1 chooses how much he is willing to pay for an advertisement that beats the Success Metric of his Champion AD. Any metric in the OAA, or calculated from the OAA, can be used as a Success Metric. Metrics found in the OAA include 3, but are not limited to, CTR, conversion rate, cost per conversion, cost per click.

The Advertiser 1 may provide additional background information (including URLs, words, descriptions, etc.) to communicate, via the System Administration Module 9 the nature of the product/service being advertised to guide Challenger Ads. The Advertiser 1 can select a number of Competition rules/options from the Competition Contest Module 5 such as: duration of Competition; uninvited challengers vs. invited challengers whereby the Advertiser 1 can expose the Competition to the entire un-invited challengers, to specific Challengers that he specifies or to a select group of people—such as employees at his own company; URL not visible; testing ads in Parallel vs. testing ads in Serial; manually accepting ad submissions vs. automatically accepting; how treat tiebreaker; and how to calculate prize.

Payment information is then collected by the E-Commerce Module 7. The Competition is then published on a website by the System Administration Module 9. The Competition continues to run until the Advertiser 1 terminates it. The Competition does not require Challenger Ads in the queue—it continues to run, waiting for new Challenger Ads.

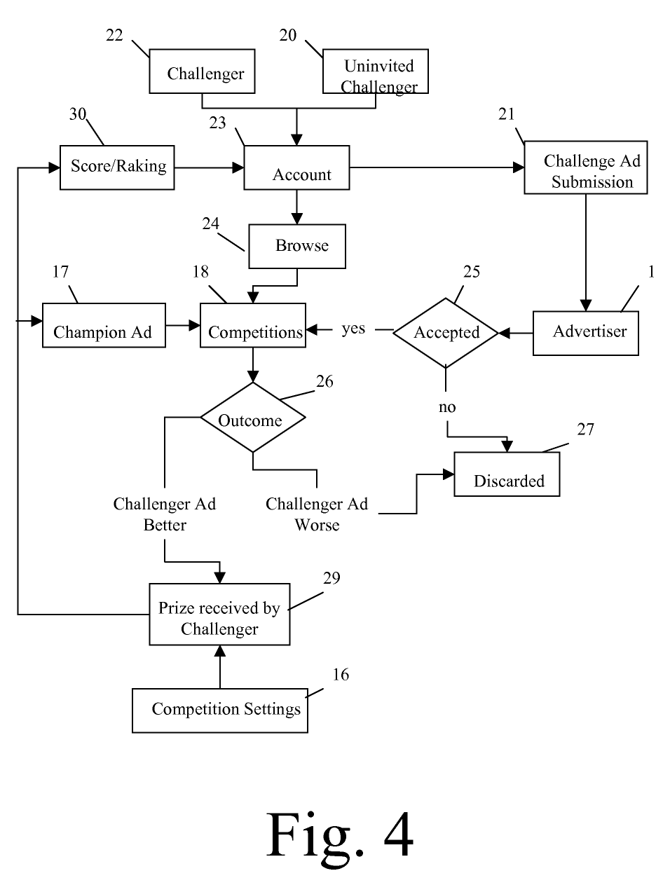

As shown in FIG. 4, Challengers 22 can search or browse 24 for Competitions 18 to enter on a variety of factors including: industry; Success Metric to beat; statistically significance level necessary to achieve; time to enter the Competition 18; when the Competition 18 was created; and number of entries in the Competition's queue. Challengers 22 submit ads known as Challenger Ads 21 to compete against the Champion ads 17. The Challenger's ad 21 will be declared the new Champion Ad 17 if it beats the existing Champion Ad's Success Metric. The Advertiser 1 logs on to his control panel to review the submissions where he has the option of accepting or rejecting submissions 25, or can provide criteria that will allow ads to be automatically accepted and rejected. The Advertiser 1 is encouraged to provide a rationale for rejecting submissions.

All submissions are held in a queue and the order of the queue can be modified by the first user at any time as desired or allowed to run in a default order selected from or provided by the system. The Challenger Ad's Success Metric is tested against the Champion Ad's Success Metric according to the Competition rules. The order of submissions that are tested against the Champion Ad 17 can be based on earliest to latest, or can be ordered based on the Advertiser's preference.

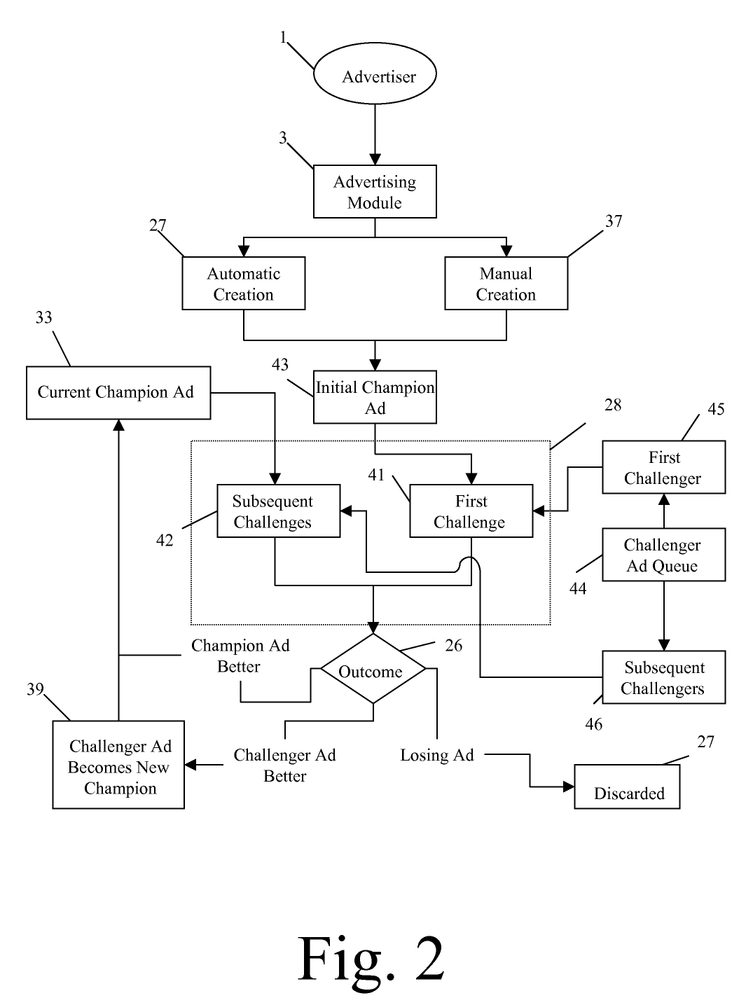

FIG. 2 is a flow chart illustrating the process for the creation of a Champion Ad 17. The present invention can create new Ad Groups and either automatically create 27 or manually create 37 an Initial Champion Ad 43. Each Competition 28 is comprised of a series of Challenges, an initial challenge 41 between the Champion Ad 17 and a first challenger ad 45 and subsequent challenges 42 between the Current Champion Ad 17 and subsequent Challenger Ads 46. Once a level of statistical significance for a Challenge has been reached a Champion Ad 17 is declared based on the Success Metric from either the current Champion Ad 17 or current Challenger Ad.

If a Challenger Ad 21 loses the Challenge it is discarded and removed from the challenger Ad queue 44. If the Challenger Ad 21 beats the Champion Ad 17 based on the Success Metric, it becomes the new Champion Ad 39 and Current Champion Ad 17. All submissions in the challenger Ad queue 44 are now run against the new Champion Ad 39. If a winner cannot be declared after a specified period as defined in the Competition rules, the Challenger Ad may be pushed to the end of the challenger Ad queue 44 or discarded 17 depending on the Advertiser's Competition rules, or a winner may be determined based on time.

The Competition 28 does not end when a new Challenger Ad 21 is declared a winner, it continues to run—even if there are no ad submissions in the challenger Ad queue 44 until the Advertiser 1 stops the Competition.

Once a winner is established, calculations are performed to determine the prize that is owed to the Challenger 2. Prizes can be a flat dollar amount for winning, can be tied to improvement over the original Champion's Success Metric, improvement over most recent Champion, or another method.

As Champions Ads 17 are replaced with new Champion Ads 39, and the threshold for the Success metric increases, it becomes more difficult for Challenger Ads 21 to win Challenges. Therefore, the prize payout can be modified at any point to increase or decrease the prize.

The Challenger ranking is adjusted based on his performance. If his ad beats the Champion Ad, then his rank may improve. Conversely, if he loses his rank may decrease.

The present invention can be utilized, but is not limited to: Website Landing pages; Radio ads; Banner ads; online text ads; Print Newspaper and magazine Ads; Video ads; Graphics on a page; and TV ads.

In alternative embodiments to the basic rules and process listed above, there may be no initial Champion, where the Invention creates the advertisement either manually or automatically. The may also require that the first ad is generated by a human. In another alternative embodiment, the payoff may be a fixed dollar amount a function of how much the challenger ad beat the champion ad, or in some cases there will be no cash prize.

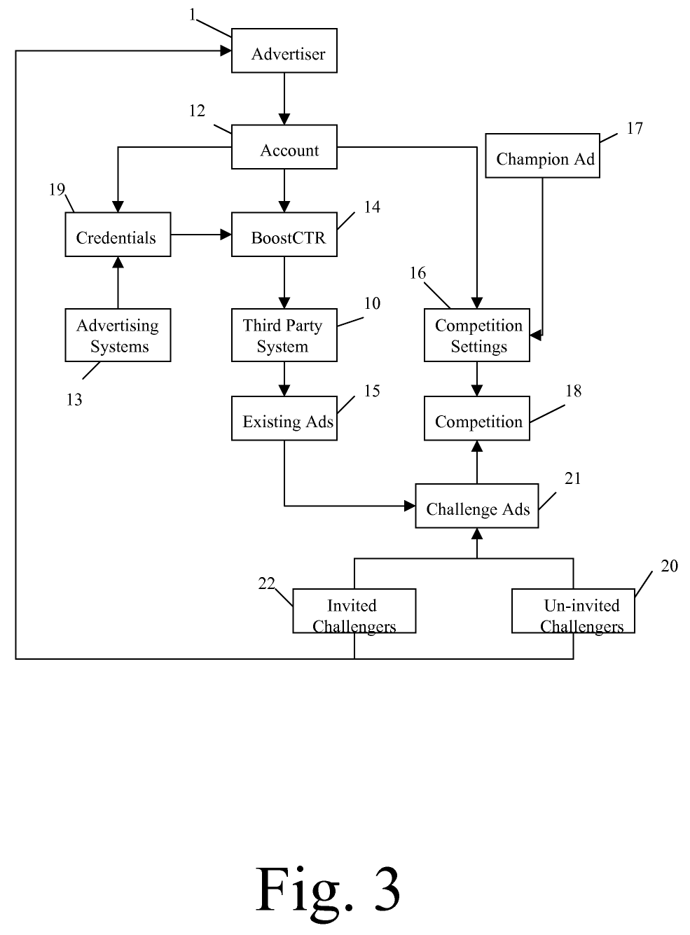

Now referring to FIG. 3, the process for an Advertiser to practice the present invention is shown. First, an Advertiser 1 signs up for an account 12. The Advertiser 1 provides credentials 19 for advertising systems 13 such as Google AdWords. BoostCTR 14 searches the third party system 10 using the credentials 19 to retrieve existing ads 15. The Advertiser 1 sets up Competition settings 16, selects the champion ad 17 and starts Competition 18. The Advertiser 1 may invite Challengers 22 to participate and/or open the Competition to the un-invited challengers 20. The Advertiser 1 receives challenge ads 21 from Challengers 22 and 20. The Advertiser 1 accepts or rejects the challenge ads 21, as they are entered by the Challengers 22 and 20.

FIG. 4 illustrates the process for an uninvited Challenger 20 and a Challenger 22 to practice the present invention. First, a Challenger 22 signs up for an account 23. The Challenger 22 searches or browses for Competitions to enter 24. The Challenger 22 submits a challenge ad 21 for Competition 18. The Challenger's ad 21 is accepted or rejected by the Advertiser 1. If accepted 25, the Challenger's ad 21 competes against current Champion Ad 17. If the Challenger's ad 21 is worse 26 than the champion ad 17, it is discarded 27. If Challenger's ad 21 is better 28 than the champion ad 17, the Challenger 22 receives a prize 29 based on the Competition settings 16. A Challenger's score/ranking 30 fluctuates to reflect performance in Competition 18.

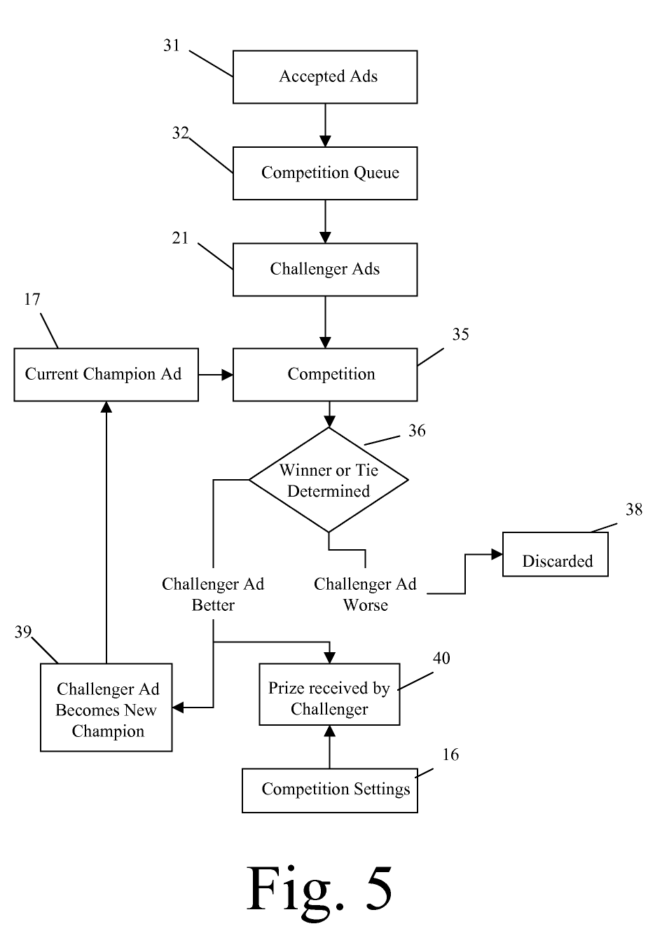

FIG. 5 illustrates the process for a Competition as structured by the process and method of the present invention. Accepted ads 31 are entered into the Competition queue 32 to compete against the current champion ad 17. Challenger Ads 18 compete in a competition 35 until a winner or tie is determined 36. Challenger ads 18 that perform worse than the champion are discarded 38. Challenger ads 18 that perform better than the current champion ad 17 become new champions 39. When a new champion 39 is declared, a prize 40 is awarded to the new champion 39, if the new champion 39 was the Challenger 40. A prize is not awarded if the current champion Ad 17 is not defeated by the Challenger 40.

The basic rules of the Competition can be easily and quickly selected or changed by an Advertiser or Administrator to create a plurality of different Competitions. Duration can be adjusted so that a Competition runs until a winner is declared by one or more variables being meet, a fixed period of time or a Min/Max criteria is completed. Alternatively, the duration of the Competition can be set by the first user to any period of time. Additionally, an Advertiser can always end Competitions at any time and Competitions can be paused by the Advertiser.

The number of ads tested per Competition can run either as: a plurality of ads versus one ad; one ad versus a plurality of ads; and a plurality of ads versus a plurality of ads.

Pricing for a Winner or multiple winners can be based on a flat fee, free, the advertiser's increased profit, reduced expense, measured improvement with respect to one or more variables, based on amount that challenger advertisement improves over champion advertisement.

The advertiser can decide the level of statistical significance that must be achieved to declare a winner or the present invention can decide the level of statistical significance that must be achieved to declare a winner. Statistical Significance can be measured against different metrics.

Types of Ad may include, but should not be limited to: Website Landing pages; Radio ads; Banner ads; online text ads; Print Newspaper and magazine Ads; Video ads; Graphics on a page; and TV ads.

Values being tested include, but should not be limited to: CTR; Conversion rate; CPA (cost per acquired customer); Total conversions in a given time period; Time on site, and page views per visit.

With respect to Challengers, rankings of Challengers may be determined in many manners such as, but not limited to: Average amount of improvement; Win percentage; Total wins; Total losses; Total ad submissions; and monetary winnings.

Accepting Challenger Submissions can be done manually or automatic based on one or more rules or the ranking of the writers.

In the event of a tie, the Champion wins or the Challenger wins based on settings, the Challenger ad is sent to the back of the queue to be run in a challenge again, the Challenge time is extended, or an Advertiser can declare a tie at any time.

Competitions may be un-invited challengers or invited challengers and an Advertiser can make a Competition open to all, invitation only, open to both all and those with invitations, or make one or more open based rules to determine those writers who may participate.

Advertisers can write ads for their own Competitions and can have multiple challenges at once. Writer can withdraw their ads from a Competition at any time for any reason.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method of soliciting, testing and selecting ads to improve the effectiveness of an advertising campaign, comprising the steps of:
(i) obtaining a champion ad and additional information for an advertiser's third party account;
(ii) displaying an offer from a first user for improving on the champion ad, wherein the offer specifies incentive for improvement, as well as conditions of submitting the ad;
(iii) receiving submissions of challenger ads from one or more users;
(iv) accepting and/or rejecting one or more submitted challenger ads for testing versus the existing champion ad;
(v) testing one or more selected submitted ads against the existing champion ad using a success metric;
(vi) declaring the submitted ads winners, losers, or tied with respect to the existing champion ad;
(vii) awarding incentives to the winning ad submissions; and
(viii) terminating the Competition.

2. The method of claim 1 wherein, the success metric is either: click through rate, conversion rate, cost per click, cost per acquisition, profit per customer, total conversions in a given time period, or a metric determined by the advertiser.

3. The method of claim 1 wherein, the duration of the Competition is set by the first user to any period of time.

4. The method of claim 1 wherein, the first user may receive submissions of challenger ads from one or more users or specifically invited users.

5. The method of claim 1 wherein, the first user may receive submissions of one or more challenger ads from one or more specifically invited groups of users.

6. The method of claim 5 wherein, the Competition consists of invited challengers.

7. The method of claim 1 wherein, the duration of the Competition is determined by the termination of the Competition by first user based on a pre-determined measure.

8. The method of claim 1 wherein,
a plurality of submitted challenger ads for testing versus the existing champion ad are tested in a singular challenge; and
the singular challenge tests the plurality of the selected submitted challenger ads against the existing champion ad using a success metric.

9. The method of claim 8 wherein, the success metric is derived from a third party.

10. The method of claim 1 wherein, one or more submitted challenger ads for testing versus the existing champion ad are arranged in a queue for testing in a plurality of successive Challenges.

11. The method of claim 10 wherein, the queue arrangement of submitted ads is modifiable by the advertiser.

12. The method of claim 10 wherein, after the declaration of a winner and loser and awarding incentives to the winning challenger ad submission, a new Challenge is started testing the winning ad against the next submitted add in the queue.

13. The method of claim 4 wherein, a user searches for Competitions to enter based on: industry; Success Metric to beat; time to enter the Competition; when Competition was created; and number of entries in the Competition's Queue.

14. The method of claim 1 wherein, the success metric consists of one or more variables.

15. The method of claim 1 wherein,
a Competition is further comprised of a series of Challenges between the existing champion ad and submitted challenger ads comprising the steps of:
testing a first existing champion ad against a first submitted challenger ad;
declaring a winning ad and a losing ad once a level of statistical significant is obtained based on the success metric or an allotted amount of time has passed;
removing the losing ad from the queue;
placing the winning ad as the existing ad; and
testing the winning ad, as the existing ad against the remaining submitted ads in the queue.

18. The method of claim 1 wherein, if a winning ad and losing ad cannot be declared after a specified period as defined in Competition rules, the submitted Ad is placed at the end of the queue.

17. The method of claim 1 wherein, ad selection for a first Ad occurs automatically based on the first user's selection criteria or manually.

18. The method of claim 1 wherein, a first ad is generated by a software program.

19. The method of claim 1 wherein a first ad is generated by a person.

20. The method of claim 12 wherein, the ordering of ads in the queue is determined by time or user arrangement

21. The method of claim 1 wherein, the Advertiser enters his own ads into the competition, becoming both an Advertiser and a Challenger.

22. The method of claim 1 further comprising access and integration with an advertiser's account held by a third party.
